(19) United States
(12) Patent Application Publication
(10) Pub. No.: US 2013/0088142 A1
(43) Pub. Date: Apr. 11, 2013

(54) ARRANGEMENT OF SOLID STATE LIGHT SOURCES AND LAMP USING SAME

(71) Applicant: Osram Sylvania Inc., Danvers, MA (US)

(72) Inventor: Steven C. Allen, Mason, OH (US)

(73) Assignee: OSRAM SYLVANIA INC., Danvers, MA (US)

(21) Appl. No.: 13/645,790

(22) Filed: Oct. 5, 2012

Related U.S. Application Data
(60) Provisional application No. 61/544,186, filed on Oct. 6, 2011.

(51) Int. Cl. H05B 33/02

(52) U.S. Cl. 313/498

(57) ABSTRACT

Arrangements of solid state light sources for color-mixing, and light sources including the same, are provided. A substrate has and a plurality of different color LED chips coupled thereto. The emitted light is mixed to produce a white light output. The LED chips are arranged on the substrate in a manner that improves color-mixing, for example, by forming LED sets including one or more LED chips of different colors, by skewing the LED chips, and/or by forming a non-rectangular array or a circular array of LED sets and/or chips. The color-mixing LED arrangement may be used in a lamp or other light source together with collimating optics to collimate and further mix the color-mixed light output from the LED arrangement. The color-mixing LED arrangement may be provided as a single package with multiple LED chips or as multiple packages of one or more LED chips.

### CROSS-REFERENCE TO RELATED APPLICATION

The present application claims priority of U.S. Provisional Patent Application No. 61/544,186, filed Oct. 6, 2011 and entitled “GROUPINGS OF SOLID STATE LIGHT SOURCES FOR COLOR MIXING”, the entire contents of which are hereby incorporated by reference.

### STATEMENT OF GOVERNMENT INTEREST

This invention was made with U.S. Government support under DOE Cooperative Agreement No. DE-EE0000611, awarded by the U.S. Department of Energy. The U.S. Government may have certain rights in this invention.

### TECHNICAL FIELD

The present invention relates to lighting, and more specifically, to color mixing of solid state light sources.

### BACKGROUND

Solid state light sources are increasingly used in lighting because of their energy efficiency and continually decreasing costs. White light is produced from solid state light sources in a variety of ways. For example, one or more solid state light sources may be mounted on a substrate, such as but not limited to a printed circuit board, which is sometimes referred to as a “chip on board” (COB) package. The one or more solid state light sources, which typically emit light of a wavelength that produces a blue color, may be covered with a phosphor and/or a mixture of phosphors, either directly within the package or remotely, to provide phosphor conversion of the light emitted from the underlying one or more solid state light sources to produce white light. Alternatively, combinations of two or more different “colors” (i.e., wavelengths of light corresponding to distinct colors) solid state light sources may be mixed together to produce white light.

### SUMMARY

Although lamps using solid state light sources have generally increased efficacy over those using “traditional” light sources, other problems and challenges have been encountered. One type of existing solid state light source package used in lamps includes an array of solid state light source chips with a planar phosphor-embedded silicone encapsulation. Although such a package frequently produces uniform color emission, maximum power and lumens may be limited as a result of phosphor heat trapped in the silicone encapsulation. Another type of solid state light source package includes a rectangular grid or array of solid state light sources, some of which generate light of a wavelength that produces a greenish-white (“mint”) color and some of which generate light of a wavelength that produces a reddish (“amber”) color, on a circuit board. Because packing the solid state light sources on the circuit board with a high density is often desirable, the rectangular array is used to allow the generally square-shaped solid state light source chips to be packed as closely as possible. Although such a package provides for high efficacy, the rectangular array may not provide the desired color-mixing when used with certain types of optics and/or may not provide the tighter beam angles desired for certain applications such as spot lights.

Embodiments of the present invention provide an arrangement of solid state light sources optimized for color-mixing with higher efficacy over the conventional arrangements described above. Embodiments further provide tighter beam angles to facilitate use, for example, in spot lights.

In an embodiment, there is provided an arrangement of solid state light sources. The arrangement includes: a substrate; and a plurality of solid state light source sets arranged on respective solid state light source regions of the substrate, each of the solid state light source sets including a first color solid state light source chip and a second color solid state light source chip coupled to the substrate and arranged immediately adjacent to each other, the first color solid state light source chip being configured to emit light of a first wavelength, the second color solid state light source chip being configured to emit light of a second wavelength different than the first color solid state light source chip, wherein each of the solid state light source sets is immediately adjacent at least two other solid state light source sets, wherein the solid state light source chips in at least one of the solid state light source sets are skewed relative to the solid state light source chips in at least another of the solid state light source sets, and wherein at least a subset of the solid state light source chips is located on an imaginary circle and at least a subset of the solid state light source chips is located inside of the imaginary circle.

In a related embodiment, the solid state light source chips may form a non-rectangular array on the substrate. In another related embodiment, the solid state light source sets may form a circular array on the substrate. In yet another related embodiment, a ratio of first color solid state light source chips to second color solid state light source chips in each of the solid state light source sets may be the same as the ratio of first color solid state light source chips to second color solid state light source chips on the substrate. In still another related embodiment, the first color solid state light source chips and the second color solid state light source chips may alternate around an imaginary circle passing through at least a subset of the solid state light source chips in the solid state light source sets.

In yet still another related embodiment, the first wavelength may correspond to light of a mint color, and the second wavelength may correspond to light of an amber color. In a further related embodiment, each of the solid state light source sets may provide a mint-to-amber ratio of 1:1 to 2:1.

In still yet another related embodiment, at least one of the first color solid state light source chips and the second color solid state light source chips may include a phosphor-converted solid state light source comprising a blue-emitting solid state light source as an excitation source for a phosphor containing element. In yet still another related embodiment, each of the solid state light source sets may include a third color solid state light source chip configured to emit light of a third wavelength. In a further related embodiment, the first wavelength may correspond to light of a mint color, the second wavelength may correspond to light of an amber color, and the third wavelength may correspond to light of a blue color.

In still yet another related embodiment, the first color solid state light source chip may be larger than the second color solid state light source chip. In yet another related embodiment, each of the solid state light source sets may include a predefined pattern of at least three solid state light source chips including the first color solid state light source chip and the second color solid state light source chip. In still another related embodiment, each of the solid state light source sets may include one first color solid state light source chip and a plurality of second color solid state light source chips.

In another embodiment, there is provided a light source. The light source includes: a substrate, wherein the substrate includes a plurality of solid state light source regions and a plurality of solid state light source sets, wherein each set in the plurality of solid state light source sets is arranged on a respective solid state light source region in the plurality of solid state light source regions, wherein each of the solid state light source sets includes a first color solid state light source chip and a second color solid state light source chip coupled to the substrate and arranged immediately adjacent to each other, the first color solid state light source chip configured to emit light of a first wavelength, the second color solid state light source chip being configured to emit light of a second wavelength different than the first wavelength, wherein each of the solid state light source sets is immediately adjacent at least two other solid state light source sets in the plurality of solid state light source sets, wherein the solid state light source chips in at least one of the solid state light source sets in the plurality of solid state light source sets are skewed relative to the solid state light source chips in at least another of the solid state light source sets, and wherein a subset of the solid state light source chips is located on an imaginary circle on the substrate and a subset of the solid state light source chips is located inside of the imaginary circle on the substrate; an optical system configured to collimate light emitted from the plurality of solid state light source sets; and a housing, wherein the housing at least partially surrounds the substrate and the optical system.

In a related embodiment, the light source may further include: a diffuser configured to scatter the collimated light, wherein the diffuser is at least partially surrounded by the housing.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a side view of a lamp including an arrangement of solid state light sources according to embodiments disclosed herein.

FIG. 2 is a side view of a lamp including an arrangement of solid state light sources and a total internal reflection (TIR) optic according to embodiments disclosed herein.

FIGS. 3-10 are schematic top views of various embodiments of arrangements of solid state light sources according to embodiments disclosed herein.

### DETAILED DESCRIPTION

As used herein, the term solid state light source is used generally to refer to one or more light emitting diodes (LEDs), organic light emitting diodes (OLEDs), polymer light emitting diodes (PLEDs), and any other semiconductor device that emits light, and including combinations thereof. A solid state light source includes, in some embodiments, more than one solid state light source connected in parallel, series, and/or combinations thereof. Further, a solid state light source includes, in some embodiments, a single semiconductor die, a set of semiconductor dies on a single substrate, a chip including multiple sets of semiconductor dies, and combinations thereof. For convenience, the term LED is used interchangeably herein with the term solid state light source.

As used herein, the term, “color” is generally used to refer to a property of radiation that is perceivable by an observer and the term “different colors” implies two different spectra with different dominant wavelengths and/or bandwidths. In addition, “color” may be used to refer to white and non-white light. Use of a specific color to describe an LED or the light emitted by the LED refers to a specific range of dominant wavelengths associated with the specific color. In particular, the term “red” when used to describe an LED or the light emitted by the LED means the LED emits light with a dominant wavelength between 610 nm and 750 nm and the term “amber” refers to red light with a dominant wavelength more specifically between 610 nm and 630 nm. The term “green” when used to describe a LED or the light emitted by the LED means the LED emits light with a dominant wavelength between 495 nm and 570 nm and the term “mint” refers to white light and/or substantially white light that has a greenish element to the white light such that it is above the Planckian curve and is in and/or substantially in the green color space of the 1931 CIE chromaticity diagram. The term “blue” when used to describe a LED or the light emitted by the LED means the LED emits light with a dominant wavelength between 430 nm and 490 nm. The term “white” generally refers to white light with a correlated color temperature (CCT) between about 2600 and 8000 K, “cool white” refers to light with a CCT substantially above 3600K, which is more bluish in color, and “warm white” refers to white light with a CCT of between about 2600 K and 3600 K, which is more reddish in color.

As used herein, the term “skewed” refers to one or more sides of an LED chip having an oblique or slanting direction or position relative to one or more sides of another LED chip. As used herein, the term “non-rectangular array” refers to an array in which the elements of the array (e.g., LED chips) are not arranged in a rectangular grid defined by rectangular coordinates such as x,y displacements from an array center. The term “circular array” refers to an array in which the elements of the array are more easily defined with polar coordinates, such as displacement from an array center (c) along a radius (r) and at a displacement angle (0), than with rectangular coordinates.

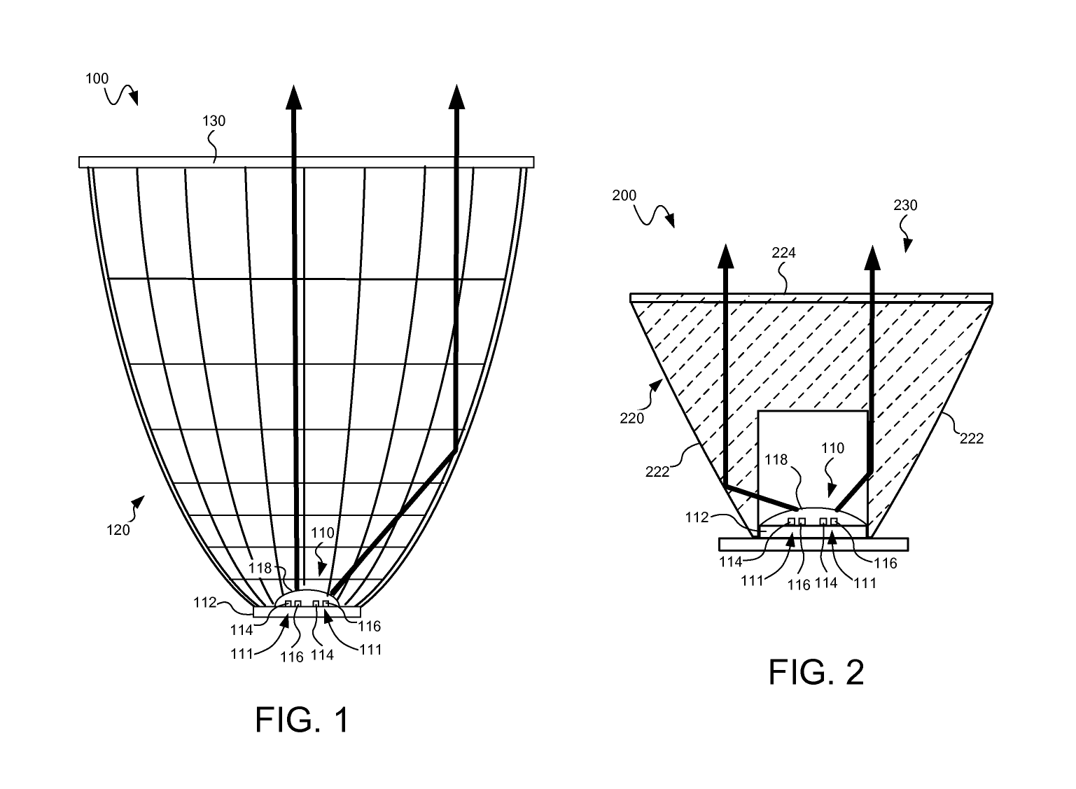

In FIG. 1, a lamp 100 includes an arrangement of LEDs 110, an optical system such as but not limited to a faceted reflector 120, and a diffuser 130. The arrangement of LEDs 110 provides a light source that emits and mixes different color light. The faceted reflector 120 reflects, collimates, and further mixes the light emitted by the arrangement of LEDs, and the diffuser 130 scatters and further mixes the light as the light passes out of the lamp 100. The lamp 100 may be used, for example but not limited to, in spot light applications with a beam angle of less than 25° and in some embodiments 20° or less. In other embodiments, an arrangement of LEDs 110 may be used in other types of lamps with other types of collimating optics and for other applications, for example, in lights with a beam angle of greater than 25° and in flood lights with a beam angle of greater than 40°.

The arrangement of LEDs 110 includes a substrate 112, a plurality of different color LED chips 114, 116 coupled to the substrate 112, and a clear dome 118 encapsulating the LED chips 114, 116. The LED chips 114, 116 include at least one first color LED chip 114 for emitting light of a first color and at least one second color LED chip 116 for emitting light of a second color different than the first color. The LED chips 114, 116 may be arranged on the substrate 112 in a manner that facilitates color-mixing while generating a relatively high flux from a relatively small area. In particular, the LED chips 114 may be arranged, for example, by forming LED sets 111 including a pattern of LED chips 114, 116 of different colors, by skewing the LED chips, and/or by forming a non-rectangular array or a circular array of LED sets and/or chips, as described in greater detail below.

The different color light emitted from the LED chips 114, 116 is mixed as the light passes through the dome 118, thereby providing good source-level color mixing. The dome 118 may include a low profile encapsulant (e.g., a clear silicone) dome that provides a full width half maximum (FWHM) beam angle of greater than 120° beam and about 150° FWHM in some embodiments. The dome 118 may be, and in some embodiments is, molded over the LED chips 114, 116 on the substrate 120, for example, using a polished aluminum mold to provide a relatively smooth surface finish to improve optical efficiency. The dome 118 may also be, and in some embodiments is, a hemisphere dome to provide greater light extraction but with less color uniformity.

In some embodiments, the first color LED chip 114 emits light of a mint color and the second color LED chip 116 emits light of an amber color such that the colors mix to produce white light. The LED chips 114, 116 may be, and in some embodiments are, arranged within a relatively small area on the substrate 112 such that the mint and amber colors are mixed, for example, to achieve a high correlated rendering index (CRI) of greater than or equal to 90, a high flux greater than about 2000 μm, and/or a high efficacy of greater than or equal to 100 LPW. The actual performance may be subject to factors including, without limitation, efficiency of the LED chips and phosphor, the number of LED chips, the drive current, the density of the LED chips, and the operating temperature. The exact size, number and arrangement of the LED chips 114, 116 depends upon the desired properties of the light source and the application. Various possible arrangements of LED chips are discussed in greater detail below. In some embodiments, the combination of the arrangement of LEDs 110 and the collimating optics may yield a high quality warm white light output with a relatively small beam angle (e.g., less than 25°) similar to a halogen spot light but with a higher luminous efficacy.

One or both of the LED chips 114, 116 may include phosphor-converted LED chips including blue-emitting LED, such as but not limited to a III-Nitride LED, as an excitation source for a phosphor containing element, such as a phosphor plate or tile, covering the blue-emitting LED. One example of the first color LED chip 114 includes a blue-emitting III-Nitride LED, such as InGaN, with a mint phosphor converter, such as green-shifted YAG:Ce, for converting the blue light to mint (also called EQ white). The mint phosphor converter provides chip level conversion (CLC) of the blue light emitted by the III-Nitride LED to the mint green wavelength range. Using a thin layer of phosphor placed directly on the LED chip allows high drive currents without phosphor overheating and minimizes optical source size (i.e., etendue). One example of the second color LED chip 116 includes an amber-emitting LED, such as InGaAlP, that directly emits amber light without phosphor conversion.

In some embodiments, the substrate 112 is a circuit board and the LED chips 114, 116 are directly bonded to the circuit board to form a multiple LED “chip on board” (COB) package. The substrate 112 may be made of, for example but not limited to, a ceramic, ceramic with metal vias, or metal core PCB including at least three layers—a metal baseplate, insulating dielectric, and metal circuit. The LED chips 114, 116 may be mechanically and electrically coupled to pads and traces (not shown) on the substrate 112 using known techniques such as but not limited to reflow soldering, epoxy bonding, and wirebonding. Using COB technology with a ceramic substrate, for example, allows close LED chip spacing (e.g., −0.1 mm edge to edge), small circuit features (e.g., 50-100 micron minimum trace widths and spacing), and excellent thermal management for generating a high flux from a small area. Although some embodiments of the color-mixing multiple LED arrangement described herein use COB technology, in other embodiments, individually-packaged LEDs, such as OSLON® LEDs available from OSRAM Opto Semiconductors of Regensberg, Germany, may also be arranged on a substrate or circuit board in the patterns described herein to improve color mixing.

Other components, such as a photo-voltaic (PV) or color sensor chip, may also be, and in some embodiments are, coupled to the substrate 112. Driver circuitry (not shown) may be coupled to the LED chips 114, 116 (e.g., via traces on the substrate 112) for driving the different color LED chips 114, 116 to achieve a desired mixing of the colors. One example of the driver circuitry is described in greater detail in commonly-owned U.S. patent application Ser. No. 13/471,650, entitled “DRIVER CIRCUIT FOR SOLID STATE LIGHT SOURCES”, the entire contents of which is incorporated herein by reference.

The arrangement of LEDs 110 may also, and in some embodiments does, include at least a third color LED chip for emitting a third color, such as blue. Using a third color LED chip allows a wider range of chromaticity and allows electronic binning by modulating the three (3) LED chips (e.g., modulating currents or pulse width modulation) to achieve the desired chromaticity. Other colors and combinations of colors are also contemplated. For example, the first color LED chip 114 may include any type of green LED chip and the second color LED chip 116 may include any type of red LED chip.

The faceted reflector 120 may, and in some embodiments does, include an aluminum coated faceted reflector to reflect, collimate and further mix the light. Other embodiments of the lamp 100 may use other types of reflectors, such as but not limited to a smooth parabolic reflector. The diffuser 130 may, and in some embodiments does, include a micro-structured polymer diffuser plate that scatters light, for example, with a scattering angle of about 5 to 10 degrees. In other embodiments, other types of diffusers may be used or the diffuser may be eliminated.

In some embodiments, the arrangement of LEDs 110 may be used with other types of light collimating optics. As shown in FIG. 2, for example, a lamp 200 includes an arrangement of LEDs 110 and a total internal reflection (TIR) optic 220 for reflecting, collimating and further mixing the LED light. Some embodiments of the lamp 200 with TIR optics 220 include faceted sidewalls 222 and a textured top surface 224 for further color-mixing. Other embodiments of the lamp 200 with TIR optics 220 may include a diffuser sheet (not shown) for scattering and further mixing the light.

FIGS. 1 and 2 show the lamps 100, 200 with a single arrangement of LEDs 110 and associated light collimating optics. Other embodiments may include multiple arrangements of LEDs 110 and associated reflectors or TIR optics. The multiple arrangements of LEDs 110 may be used, for example but not limited to, in a spotlight module with three color-mixing multiple LED arrangements 110 (e.g., 5 Watts each) and three associated reflectors or TIR optics.

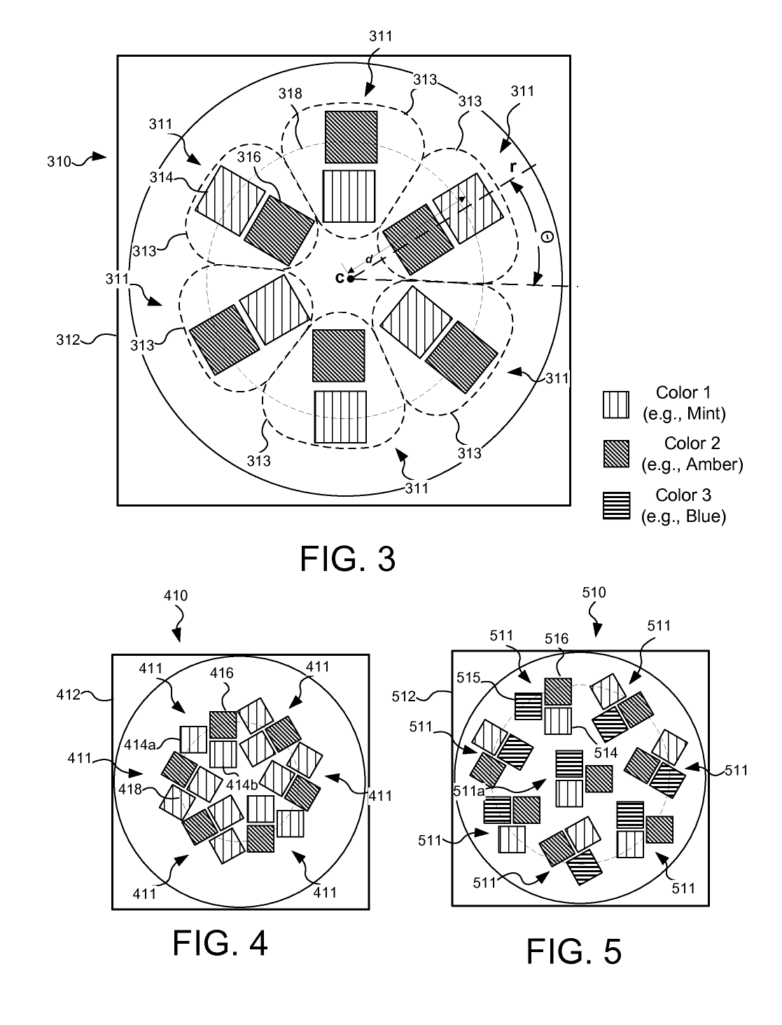

Referring to FIGS. 3-10, various embodiments of arrangement of LEDs are shown and described in greater detail. Each of the arrangement of LEDs shown and described herein includes at least two different color LED chips arranged in adjacent LED sets, skewed relative to other LED chips, and/or arranged in a circular array to improve color mixing in the angular and/or radial directions. Although specific arrangements of LED chips and LED sets are shown, other arrangements are possible and within the scope of the present disclosure. The illustrated embodiments include at least mint and amber LED chips with a mint-to-amber ratio between 1:1 and 2:1 to achieve the desired color mixing; however, other colors and color ratios are also possible. The number, size and arrangement of the LED chips may be determined based on the desired properties of the color-mixing LED light source (e.g., power input, flux, efficacy, source diameter, brightness, color uniformity, and CRI).

In FIG. 3, an arrangement of LEDs 310 includes a plurality of LED sets 311 with at least two LED chips 314, 316 of two different colors arranged on respective LED regions 313 on a substrate 312. The LED chips 314, 316 are skewed to allow arrangement in a circular array such that each of the LED sets 311 is immediately adjacent two other such LED sets 311 in the circular array. In FIG. 3, each of the LED sets 311 includes a pattern of one mint LED chip 314 and one amber LED chip 316 arranged immediately adjacent to each other (i.e., without other LED chips in between), and the LED chips 314, 316 are substantially the same size with the same number of mint LED chips 314 as amber LED chips 316 to provide a mint-to-amber ratio of 1:1. As shown, each of the LED sets 311 may have the same mint-to-amber ratio as the overall mint-to-amber ratio of the LED arrangement 310 on the substrate 312.

The LED sets 311 and the individual LED chips 314, 116 are arranged in a circular array on the substrate 312 to facilitate color-mixing. In other words, each of the LED chips 314, 316 is located at a displacement d from an array center (c) along a radius (r) and at displacement angle Θ. The LED chips 314, 316 are also arranged such that a subset of the LED chips 314, 316 is located on an imaginary circle 318 with the mint and amber colors alternating along the imaginary circle 318 and such that a subset of the LED chips 314, 316 is located inside of the imaginary circle 318. The LED chips 314, 316 thus extend in radial and angular directions. By grouping the LED chips 314, 316 and alternating the colors in the angular direction, the mint and amber colors are substantially balanced to improve color mixing. Arranging the LED chips 314, 316 in the circular array with the different colors balanced in the angular direction allows good color mixing when used in a circular lamp with a circular aperture. Although FIG. 3 shows the LED chips 314, 316 arranged in a circular array, other embodiments may and do include skewed LED chips arranged in other non-rectangular arrays.

In FIG. 4, an arrangement of LEDs 410 includes a circular array of adjacent LED sets 411 of three (3) LED chips 414a, 414b, 416 having two different colors arranged on a substrate 412. Each of the LED sets 411, for example, includes a predefined pattern of two mint LED chips 414a, 414b and one amber LED chip 416 of substantially the same size, providing a mint-to-amber ratio of 2:1 in each of the LED sets 411. The six (6) LED sets 411 provides a total of twelve (12) mint LED chips 414a, 414b and six (6) amber LED chips 416. The LED chips 414a, 414b, 416 are skewed to allow the LED sets 411 to be arranged in the circular array, and the different colors (e.g., mint and amber) alternate along an imaginary circle 418 passing through a subset of the LED chips 414a, 416. In FIG. 4, a subset of the LED chips 414a, 416 are located along the imaginary circle 418 and a subset of the LED chips 414b are located inside of the imaginary circle 418 such that the LED chips extend both radially and angularly relative to the circular array.

In FIG. 5, an arrangement of LEDs 510 includes a circular array of LED sets 511 of three LED chips 514, 515, 516 having three different colors arranged on a substrate 512. Each of the LED sets 511, for example, includes a predefined pattern of one mint LED chip 514, one blue LED chip 515, and one amber LED chip 516 of substantially the same size. The LED chips 514, 515, 516 are skewed to allow the LED sets 511 to be arranged in the circular array with an additional LED group 511a at the center region. The three different colors (e.g., mint, amber, and blue) alternate in an angular direction along an imaginary circle 518 passing through a subset of the LED chips, and LED chips are located both on the imaginary circle 518 and inside of the imaginary circle 518.

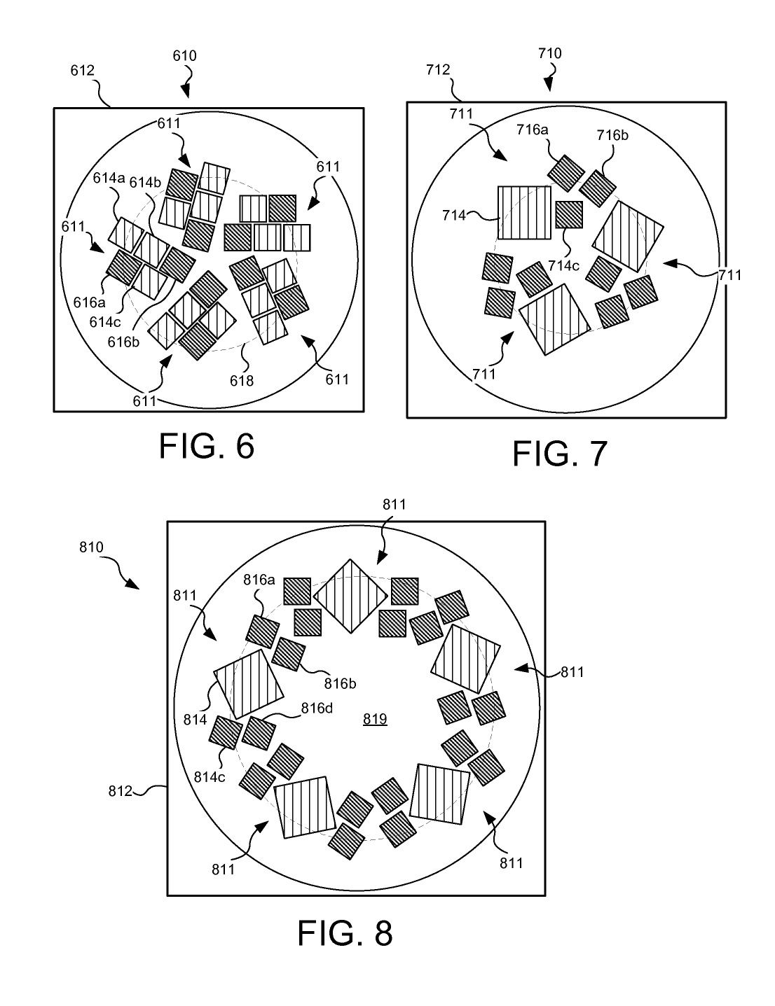

In FIG. 6, an arrangement of LEDs 610 includes a circular array of LED sets 611 of five (5) LED chips having two different colors arranged on a substrate 612. Each of the LED sets 611, for example, includes a predefined pattern of three mint LED chips 614a-c and two amber LED chips 616a, 616b of substantially the same size, providing a mint-to-amber ratio of 3:2 in each of the LED sets 611 and overall. In FIG. 6, the five (5) LED sets 611 provides a total of 15 mint LED chips and 10 amber LED chips. The LED chips 614a-c, 616a, 616b may be, and in some embodiments are, skewed to allow the LED sets to form the circular array, and the different colors (e.g., mint and amber) alternate in an angular direction along the imaginary circle 618 passing through a subset of the LED chips. In FIG. 6, a subset of the LED chips 614a, 616a are located along the imaginary circle 618 and a subset of the LED chips 614b, 614c, 616c are located inside of the imaginary circle 618 such that the LED chips extend both radially and angularly relative to the circular array.

As shown in FIG. 6, the LED chips 614a-c, 616a, b may also be closely packed on the substrate to reduce the size of the array. As used herein, “closely packed” refers to LED chips that are positioned close enough such that there is insufficient space for another LED chip, which may, and in some embodiments does, include a single LED semiconductor die. A smaller, closely-packed array with skewed LED chips arranged as described herein enables a tight beam (i.e., a smaller beam angle) with good color mixing, which is particularly desirable in, for example but not limited to, spot light applications. In one example, twenty-five (25) 1 mm×1 mm LED chips (i.e., 15 mint and 10 amber) may be closely packed to provide a light source diameter of about 12.3 mm.

In FIG. 7, an arrangement of LEDs 710 includes a circular array of LED sets 711 of four (4) LED chips having two different colors and different sizes arranged on a substrate 712. Each of the LED sets 711, for example, includes a predefined pattern of one larger mint LED chip 714 and three smaller amber LED chips 716a-716c. The larger mint LED chip 714 has a surface area, for example, that is about 4 times the surface area of the smaller amber LED chips 716a-716c, thereby providing a mint-to-amber ratio of 4:3 in each of the LED sets 711 and overall. The LED chips 714, 716a-716c are skewed to allow the LED sets 711 to form the circular array with alternating mint and amber colors. In some embodiments, the larger LED chip 714 is substantially 1 mm² (1 mm×1 mm) and the smaller LED chips 716a-716c is substantially 0.25 mm² (0.5 mm×0.5 mm), and three (3) 1 mm² mint LED chips 714 and nine (9).25 mm² amber LED chips are arranged in a circular pattern on a 6.6 mm square substrate.

In FIG. 8, an arrangement of LEDs 810 includes a circular array of LED sets 811 of five (5) LED chips having two different colors and different sizes arranged on a substrate 812. Each of the LED sets 811, for example, includes a predefined pattern of one larger mint LED chip 814 and four smaller amber LED chips 816a-816d. The larger mint LED chip 814 has a surface area, for example, that is about 4 times the surface area of the smaller amber LED chips 816a-816c, thereby providing a mint-to-amber ratio of 1:1. The LED chips 814, 816a-816d are skewed to allow the LED sets 811 to form the circular array alternating one (1) larger mint LED chip 814 and four (4) smaller amber LED chips 816a-816d around the circle. In some embodiments, five (5) 1 mm² mint LED chips 814 and twenty (20).25 mm² amber LED chips are arranged in a circular array on a 10 mm square substrate. In FIG. 8, the LED sets 811 are formed in the circular array with an open center region 819 for other components, such as but not limited to a photovoltaic chip and/or another type of sensor.

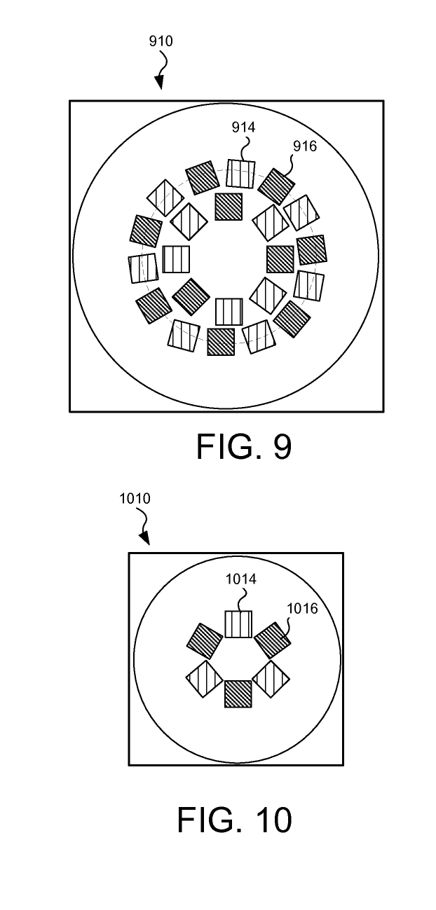

FIG. 9 shows an arrangement of LEDs 910 including concentric circular arrays of alternating mint LED chips 914 and amber LED chips 916. FIG. 10 shows an arrangement of LEDs 1010 including a circular array of alternating mint LED chips 1014 and amber LED chips 1016.

Although the illustrated embodiments show specific examples of arrangements of LEDs with LED sets and/or arrangements of LED chips, other patterns, numbers, sizes, combinations and colors of LED chips may also be arranged in LED sets and/or in a circular array or other non-rectangular array. Also, each of the illustrated embodiments is not intended to be exclusive, and additional LED sets and/or LED chips may be coupled at other locations on the substrates in addition to or outside of the patterns and arrangements shown. Other components, such as a photovoltaic chip, may also be coupled to the substrates. Accordingly, the arrangements of LEDs described herein may facilitate color mixing while providing a high efficacy light source. In particular, a lamp including one or more of such arrangements of LEDs may provide good color mixing and high efficacy with a relatively small beam angle suitable for certain lighting applications.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. An arrangement of solid state light sources, comprising:
a substrate; and
a plurality of solid state light source sets arranged on respective solid state light source regions of the substrate, each of the solid state light source sets including a first color solid state light source chip and a second color solid state light source chip coupled to the substrate and arranged immediately adjacent to each other, the first color solid state light source chip being configured to emit light of a first wavelength, the second color solid state light source chip being configured to emit light of a second wavelength different than the first color solid state light source chip, wherein each of the solid state light source sets is immediately adjacent at least two other solid state light source sets, wherein the solid state light source chips in at least one of the solid state light source sets are skewed relative to the solid state light source chips in at least another of the solid state light source sets, and wherein at least a subset of the solid state light source chips is located on an imaginary circle and at least a subset of the solid state light source chips is located inside of the imaginary circle.

2. The arrangement of solid state light sources of claim 1, wherein the solid state light source chips form a non-rectangular array on the substrate.

3. The arrangement of solid state light sources of claim 1, wherein the solid state light source sets form a circular array on the substrate.

4. The arrangement of solid state light sources of claim 1, wherein a ratio of first color solid state light source chips to second color solid state light source chips in each of the solid state light source sets is the same as the ratio of first color solid state light source chips to second color solid state light source chips on the substrate.

5. The arrangement of solid state light sources of claim 1, wherein the first color solid state light source chips and the second color solid state light source chips alternate around an imaginary circle passing through at least a subset of the solid state light source chips in the solid state light source sets.

6. The arrangement of solid state light sources of claim 1, wherein the first wavelength corresponds to light of a mint color, and wherein the second wavelength corresponds to light of an amber color.

7. The arrangement of solid state light sources of claim 6, wherein each of the solid state light source sets provides a mint-to-amber ratio of 1:1 to 2:1.

8. The arrangement of solid state light sources of claim 1, wherein at least one of the first color solid state light source chips and the second color solid state light source chips includes a phosphor-converted solid state light source comprising a blue-emitting solid state light source as an excitation source for a phosphor containing element.

9. The arrangement of solid state light sources of claim 1, wherein each of the solid state light source sets includes a third color solid state light source chip configured to emit light of a third wavelength.

10. The arrangement of solid state light sources of claim 9, wherein the first wavelength corresponds to light of a mint color, wherein the second wavelength corresponds to light of an amber color, and wherein the third wavelength corresponds to light of a blue color.

11. The arrangement of solid state light sources of claim 1, wherein the first color solid state light source chip is larger than the second color solid state light source chip.

12. The arrangement of solid state light sources of claim 1, wherein each of the solid state light source sets includes a predefined pattern of at least three solid state light source chips including the first color solid state light source chip and the second color solid state light source chip.

13. The arrangement of solid state light sources of claim 1, wherein each of the solid state light source sets includes one first color solid state light source chip and a plurality of second color solid state light source chips.

14. A light source, comprising:
a substrate, wherein the substrate includes a plurality of solid state light source regions and a plurality of solid state light source sets, wherein each set in the plurality of solid state light source sets is arranged on a respective solid state light source region in the plurality of solid state light source regions, wherein each of the solid state light source sets includes a first color solid state light source chip and a second color solid state light source chip coupled to the substrate and arranged immediately adjacent to each other, the first color solid state light source chip configured to emit light of a first wavelength, the second color solid state light source chip being configured to emit light of a second wavelength different than the first wavelength, wherein each of the solid state light source sets is immediately adjacent at least two other solid state light source sets in the plurality of solid state light source sets, wherein the solid state light source chips in at least one of the solid state light source sets in the plurality of solid state light source sets are skewed relative to the solid state light source chips in at least another of the solid state light source sets, and wherein a subset of the solid state light source chips is located on an imaginary circle on the substrate and a subset of the solid state light source chips is located inside of the imaginary circle on the substrate;
an optical system configured to collimate light emitted from the plurality of solid state light source sets; and
a housing, wherein the housing at least partially surrounds the substrate and the optical system.

15. The light source of claim 14, further comprising:
a diffuser configured to scatter the collimated light, wherein the diffuser is at least partially surrounded by the housing.
